(19) United States
(12) Patent Application Publication
(10) Pub. No.: US 2018/0130132 A1
(43) Pub. Date: May 10, 2018

(54) ANNUITY ANALYSIS SYSTEM

(71) Applicant: Cannex Financial Exchanges Limited, Toronto (CA)

(72) Inventors: Faisal Habib, Markham (CA); Branislav Nikolic, Toronto (CA); Thomas S. Salisbury, Toronto (CA)

(21) Appl. No.: 15/803,110

(22) Filed: Nov. 3, 2017

Related U.S. Application Data
(60) Provisional application No. 62/417,743, filed on Nov. 4, 2016.

(51) Int. Cl. G06Q 40/06; G06Q 40/08

(52) U.S. Cl. CPC G06Q 40/06; G06F 8/10; G06Q 40/08

(57) ABSTRACT

The present invention is a system that uses a computer processor to determine for a client a present economic value and standard deviation of the present economic value of an annuity contract. The value is calculated based on a lapse value representing the value to the client of the flexibility to exit the annuity contract at any point of time, a death value representing the present value of the life insurance component of the annuity contract that is provided to the estate upon the death of the client, and an income value representing the actuarial present value of future income derived from the annuity contract. The average value and standard deviation of the lapse value, death value and income value are calculated by the computer processor by performing Monte Carlo simulations.

### FIELD OF THE INVENTION

The present invention relates to analysis and evaluation of annuity products performed by a computer system.

### BACKGROUND OF THE INVENTION

Variable annuities (VAs) are the most popular form of annuity purchased in the U.S. market today, and the majority of those sold (over 70%) contain some form of living benefit rider which allows the purchaser to “turn on” an option to receive regular income from the annuity.

Compared to other savings and retirement products, variable annuities are complex products. As a result VA sales are subject to considerable scrutiny by U.S. regulators. In recent years, sizeable fines resulting from inadequate controls or procedures to monitor the suitable sale of these products have been imposed on broker-dealers by the Financial Industry Regulatory Authority (FINRA).

More recently, the Department of Labor (DOL) has announced a proposed new fiduciary standard whereby the advisor—or rather, their firm—will have to deliver proof that the recommendation of a VA (or FIA—Fixed Indexed Annuity) is in the “best interest” of a client rather than being merely “suitable.”

Those factors—the popularity of VAs, their complexity and the expanding requirement to demonstrate the benefit to clients of a VA transaction—lead to a need on the part of financial advisors (and their firms) for a way to transparently assess a proposed VA transaction. However, this need is hard to fulfill. The challenge in assessing the potential benefit (or cost) of an annuity transaction stems from two primary issues.

The first is a cost comparison issue which arises when the size and scope of various fees and expenses in an annuity contract or contracts do not directly correlate to the benefits received by the client. Similarly, the size and scope of rates set out in an annuity contract (i.e., a guaranteed withdrawal rate, a roll-up rate, and so on) may not necessarily correlate to the size of the benefit to the client. For example, is a higher guaranteed withdrawal rate, such as 6% versus 5%, (always) better than a lower rate? In some cases, depending on client and other circumstances, the answer may be “no.”

The second challenge is a product alignment issue which arises when the performance of a specific product may work well for some people and in some circumstances and not so well for others. Said another way, the client profile, along with their intended use of the specific product or product features, can impact the value of the benefit they receive from the product. For any annuity contract, all investors are not created equal.

Today, the primary tools available to assist an advisor with their due diligence for VA or FIA sales are either composite comparisons of static fees and product specifications for two or more products, or stand-alone illustrations obtained directly from each carrier which advisors can then use in efforts to compare products.

An annuity contract consists of two components: the deferral phase and the annuity phase.

With an income annuity—otherwise known as a pension annuity—the deferral phase is specifically defined at purchase before a series of periodic payments begins at the start of the annuity phase. Income annuities include the single-premium income annuity, or SPIA; the deferred income annuity or DIA, and the qualified longevity annuity contract or QLAC.

With a deferred annuity—otherwise known as a savings annuity—the deferral phase is open-ended and not defined, and the annuity phase is rarely triggered. Deferred annuities include variable annuities, indexed annuities and fixed rate annuities. Deferred annuities are typically positioned in the marketplace as savings products that can be converted into guaranteed income later, if needed.

When first introduced into the market in the 1950s, VAs were sold as products that provided an investor with the ability to receive a death benefit on their fund investments. With a VA, as the funds were held inside an insurance contract, the investor received the additional benefit of tax deferral on earnings growth, as well as tax-free transfers between funds within the contract.

Towards the end of the twentieth century, the concept of an additional living benefit was introduced to VA contracts to provide greater flexibility on how guaranteed income might be provided from the contract.

Academics and retirement planning specialists have long known that using a portion of a client's assets to purchase an income or pension annuity can help mitigate various risks (such as longevity, for example) in retirement. Traditionally, however, investors have been wary of purchasing income annuities—or “committing to the annuity phase”—because of the loss of control of their assets which the annuity purchase or phase represents.

In contrast to the traditional pension annuity, the living benefit provides a way to offer guaranteed income (or maintain a future income level) during the deferral phase of the contract, while still providing access to the account value. The rise and evolution of the living benefit option within the VA and FIA market has much to do with the behavioral finance challenge of finding the appropriate trade-off between the individual's desire to maintain control and access to their savings versus the long-term need or preference to maintain the security of guaranteed lifetime income.

Many retirees may initially attempt to maintain as much control as possible over their assets in an Individual Retirement Account (IRA) or other investment accounts—meaning they generally avoid annuitizing their portfolios. However, by doing so, as retirement proceeds they may run the risk of outliving their nest egg and/or altering their lifestyle if investments do not perform as expected (or hoped).

Consistent with this finding, a majority of income annuity sales occur only when they are framed by the advisor as part of an overall portfolio which is itself part of a broader financial plan—but that sales process can involve a lot of time and effort (and trust) by both the advisor and the client. However, research has shown that the allocation to a VA (or FIA) with a Living Benefit along with investments and an income annuity (i.e., all 3) can further optimize a retirement portfolio whereby the VA acts as a pendulum between growth and a guarantee. In good markets, the VA performs like an investment and in bad markets it performs more like an income annuity. With a living benefit, the client (and the advisor) can essentially have their cake and eat it too: asset control coupled with income security. But this easy “behavioral fix” (“the option is there if you need it or want it; you don't need to decide or commit right now”) comes at a price. Sonic people are willing to pay for that future option.

Today, annuity consumers have the option to buy one or both of a death benefit and living benefit embedded in the annuity contract; and they will make their choice about purchasing these benefits depending upon the options presented to them, their financial planning needs and preferences, and how they value the convenience of packaging.

However, the valuation and comparison of the additional death benefit and living benefit within the annuity contract can be very difficult to measure quantitatively—not only between competing variable annuity products, but against a combination of other products that could possibly service the same needs without the convenience of bundling and packaging.

Today, the most popular form of living benefit in the market is the Guaranteed Lifetime Withdrawal Benefit (GLWB). With this benefit, once an investor decides to start taking systematic withdrawals from their account, that withdrawal amount will be guaranteed for their lifetime, even if the account value falls to $0.

Previously, when living benefits were first introduced in the market, the Guaranteed Minimum Income Benefit (GMIB) was the primary form of benefit. However, triggering this benefit ultimately required the investor to enter the annuity phase of the contract in order to receive periodic payments.

Whether contemplating the GLWB or the GMIB, in both cases the level of the payout benefit is partly determined by the performance of a “shadow account” within the annuity contract, otherwise known as a benefit base. Over time, the value of this benefit base tends to increase, both as a result of an upward market performance of the underlying investments as well as from a number of stipulated rules and formulae defined within the contract itself. However, irrespective of the performance of the shadow account or benefit base, the living benefit continues to provide income for as long as the client is alive even if the underlying account on which the income was based has been exhausted.

In technical terms, a living benefit on a variable annuity can be thought of as an exotic put option (Huang, H., Milevsky, M. and Salisbury, T. Complete Market Valuation of the Ruin-Contingent Life Annuity (RCLA). Journal of Risk and Insurance (Jan. 16, 2009)) that is triggered when the contract enters the annuity phase—with the option triggered either automatically (for a GLWB when the account value is exhausted) or manually (for a GMIB within a defined time frame).

In today's market, the sale of a variable annuity is generally supported with a presentation of product specifications, accompanied by illustrations that provide deterministic scenarios (i.e., no incorporation of randomness), that together endeavor to depict potential future outcomes of the proposed investment.

A comparative assessment of two or more products will usually focus on the specifications for fees as well as an evaluation of the nominal rider benefits (e.g., a roll-up rate of 5%). Comparing product illustrations can be challenging, however, as capital market assumptions and other pricing variables are not consistent from carrier to carrier.

There are three main challenges which can cloud efforts to provide transparent and straightforward assessments of the economic value of a proposed annuity transaction for the purchaser.

### Challenge 1: The Level of Fees and Expenses Does Not Correlate to the Level of Benefit Received by the Investor

As part of the sales and compliance process, advisors compare a variety of fees—including Mortality & Expense (M&E), sales/contingent deferred sales charges (CDSC), rider fees and fund management fees.

Sometimes, the focus on fees and charges is emphasized to such a degree that the transaction is evaluated through that lens only. However, even with a close focus on fees and costs it can be very difficult to understand how the fees and charges in one contract will impact how that contract might perform against another contract with its own set of fees and charges.

Various fees often do not correspond directly with the individual benefits that are offered within the product—and, somewhat counterintuitively, higher contract fees do not always mean the client is worse off.

### Challenge 2: Bigger is Not Always Better

Another area of potential confusion in assessing annuity contracts is understanding the value of the embedded benefits that may be purchased with a new contract or surrendered with an existing one. Similar to the fee issue, a higher withdrawal rate or roll-up rate, while they may appear superficially attractive and beneficial, do not necessarily equate to a better outcome for the client. Instead, a deeper quantitative look is needed to be able to differentiate among many features, their value and their usefulness to the particular individual.

### Challenge 3: Different Combinations Produce Different Results

Finally, the outcomes from a contract derived from the unique combination of rider specifications with defined rules and parameters within a product are not at all obvious. For example, a contract may have three different share class options, three GLWB options and two death benefit options (in addition to other fee variations based on state, premium amounts, and more).

That set represents 18 potential combinations which will produce a wide variety of outcomes. But that range of combinations is only based on the product specifications—when the profile of the client (i.e., age and gender) is added and combined with an anticipated start date for income, the variability expands even further.

The client and advisor, who are trying to determine the best choice for the client, are left with an unwieldy set of alternatives for which the impact of various levers and dials (e.g., change the income start date, or choose a different GLWB or death benefit option?) is largely opaque.

### SUMMARY OF THE INVENTION

A scoring methodology for annuity transactions is defined herein that is intended to improve current evaluation practices, and empower financial institutions, their advisors and annuity clients to make more informed decisions about these transactions. By adopting the methodology set out here, the due diligence and product selection processes for annuity sales may be enhanced, thus improving the advisor's and firm's ability to meet compliance and regulatory obligations.

The described approach compares annuities in a dynamic setting (by running Monte Carlo simulations) and accounts for prevailing capital market assumptions, mortality rates, lapse experiences, and individual annuity design parameters, in contrast to prior art that uses static side by side comparison of annuity parameters only.

By performing an analysis in a dynamic setting, it is possible to see how two or more annuities will perform and provide benefits to the annuitants. The benefits include lapse/liquidity value, legacy (death) value, or lifetime income value. This allows the annuitant to choose the products based on the benefits provided to them as opposed to comparing product features.

The described approach makes use of client demographic information (age & gender) which allows unique determination of the most suitable annuity for the client according to their preferences for lifetime income or death benefits. Annuity designs are not identical and therefore side-by-side comparison of features provide little to no value. Likewise, no single annuity is suitable across all client demographics therefore it is necessary to account for the annuitant's age and gender.

A system comprising a computer processor configured to determine for a client a present economic value and standard deviation of the present economic value of an annuity contract based on a lapse value representing the value to the client of the flexibility to exit the annuity contract at any point of time, a death value representing the present value of the life insurance component of the annuity contract that is provided to the estate upon the death of the client, and an income value representing the actuarial present value of future income derived from the annuity contract, wherein the average value and standard deviation of the lapse value, death value and income value are calculated by the computer processor by performing Monte Carlo simulations.

More specifically, the invention provides a system that includes a computer processor configured to determine for a client a present economic value and standard deviation of the present economic value of an annuity contract. The present economic value is calculated based on a lapse value representing the value to the client of the flexibility to exit the annuity contract at any point of time, a death value representing the present value of the life insurance component of the annuity contract that is provided to the estate upon the death of the client, and an income value representing the actuarial present value of future income derived from the annuity contract. The average value and standard deviation of the lapse value, death value and income value are calculated by the computer processor by performing Monte Carlo simulations.

The present economic value to the client of the annuity is preferably calculated to be the sum of the average values of the lapse value, death value and income value of the annuity. The standard deviation of the present economic value to the client of the annuity may be estimated by performing a Monte Carlo simulation.

The annuity may provide a Guaranteed Lifetime Withdrawal Benefit (GLWB) and the income value may then be determined based on withdrawal rate and income benefit base of the GLWB.

The Monte Carlo simulations may account for prevailing capital market assumptions, mortality rates, lapse experiences, or individual annuity design parameters and combinations thereof.

The invention also provides a method for evaluating an annuity contract for a client. The evaluation is done by a computer processor A present economic value and standard deviation of the present economic value of the annuity contract are determined based on a lapse value representing the value to the client of the flexibility to exit the annuity contract at any point of time, a death value representing the present value of the life insurance component of the annuity contract that is provided to the estate upon the death of the client, and an income value representing the actuarial present value of future income derived from the annuity contract. The average value and standard deviation of the lapse value, death value and income value are calculated by the computer processor by performing Monte Carlo simulations. The present economic value to the client of the annuity is preferably calculated to be the sum of the average values of the lapse value, death value and income value of the annuity. The standard deviation of the present economic value to the client of the VA may be estimated by performing Monte Carlo simulations. The annuity may provide a Guaranteed Lifetime Withdrawal Benefit (GLWB) and the income value may then be determined based on withdrawal rate and income benefit base of the GLWB. The Monte Carlo simulations may account for prevailing or forward looking capital market assumptions, mortality rates, lapse experiences, or individual annuity design parameters and combinations thereof.

The invention also provides a method of selecting one of multiple candidate annuities for a client, by performing the above-summarized method for each of the annuities and selecting the annuity with the greatest present economic value to the client.

### BRIEF DESCRIPTION OF THE DRAWINGS

FIG. 1 is a histogram of the differences in lapse value of Product B and Product A.

FIG. 2 is a histogram of the differences in death value of Product B and Product A.

FIG. 3 is a histogram of the differences in income value of Product B and Product A.

FIG. 4 is a histogram of the differences in total economic value of Product B and Product A.

FIGS. 5a, 5b and 5c are a flowchart for the calculation of a simple type of VA/GLWB. The letters A, B, C and D indicate how certain arrows connect between the figures.

FIGS. 6a and 6b are a flowchart for the calculation of a simple type of VA/GLWB, including joint mortality formulas. The letters E, F and G indicate how certain arrows connect between the figures.

### DETAILED DESCRIPTION OF THE INVENTION

A variable annuity is a long-term investment primarily designed to support retirement needs (e.g., retirement income, estate planning, etc.). Therefore the main objective in reviewing a potential annuity transaction must be to assess the economic suitability of the transaction given the intended nature of these products, versus any ancillary benefit or function that these contracts might fulfill.

In order to accomplish this task, it is essential that first, the assessment is consistent from a financial and actuarial perspective—that is, it must be replicable from product to product and across different economic environments—and next, that the results be communicated in a simple and transparent manner which highlights the basic components of the contract that have been bundled together.

This is where the present system and methodology for evaluating and scoring proposed annuity transactions in the context of retirement income and estate planning comes in. The analysis includes three main steps: first, determining the present economic value of a specific annuity contract; secondly, exploring the variability of the values around the average economic value; and finally determining the net economic value of a proposed annuity transaction or comparing a group of annuity contracts individually by their values. This multi-step approach allows advisors and their clients to move beyond the current practices for evaluating and recommending annuity transactions, in which advisors rely on qualitative analysis of potential outcomes, and towards a robust, transparent, and repeatable quantitative methodology for reviewing, assessing and recommending annuity transactions.

The magnitude and structure of various fees can be a significant factor when valuation is performed. When comparing product specifications side by side one can easily spot any nominal difference in fees between products, however, it is important to fully understand what an investor is actually receiving for a certain tee (e.g., what does each feature provide, relative to its cost?). The described valuation assessment can help a decision-maker understand this relationship by incorporating the cumulative effects of various fees onto each of the components of the economic value.

The present system requires a computer processor or processors to perform the required calculations, such as performing a Monte Carlo simulations, and the associated methods must be performed by a computer processor or processors.

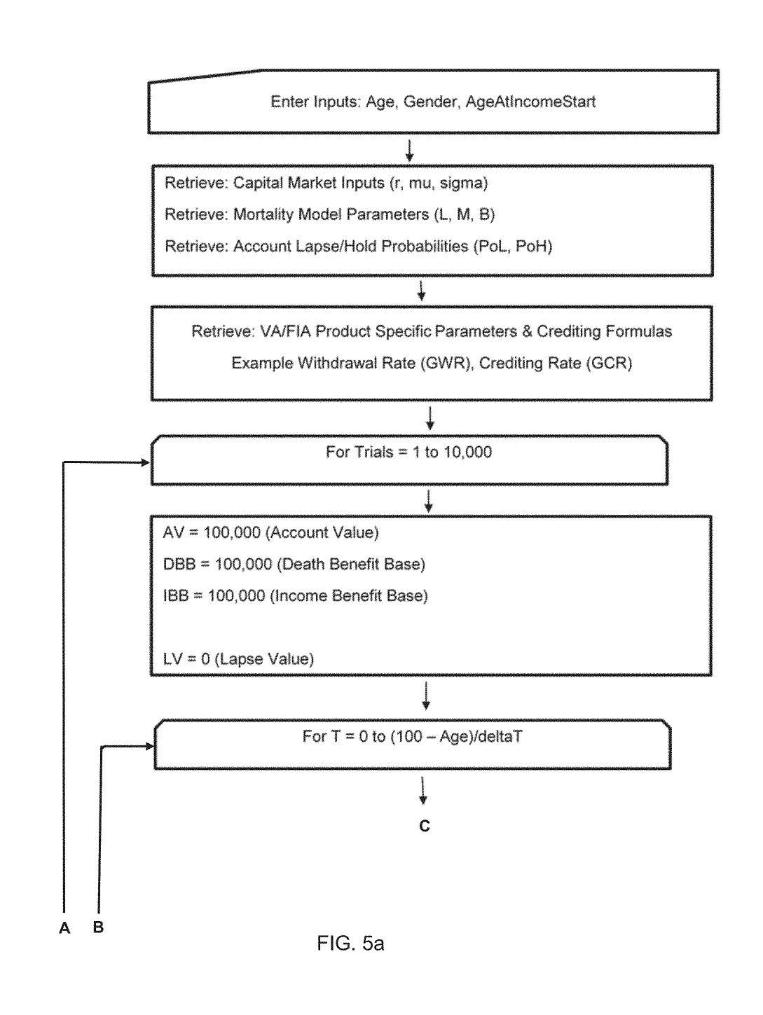

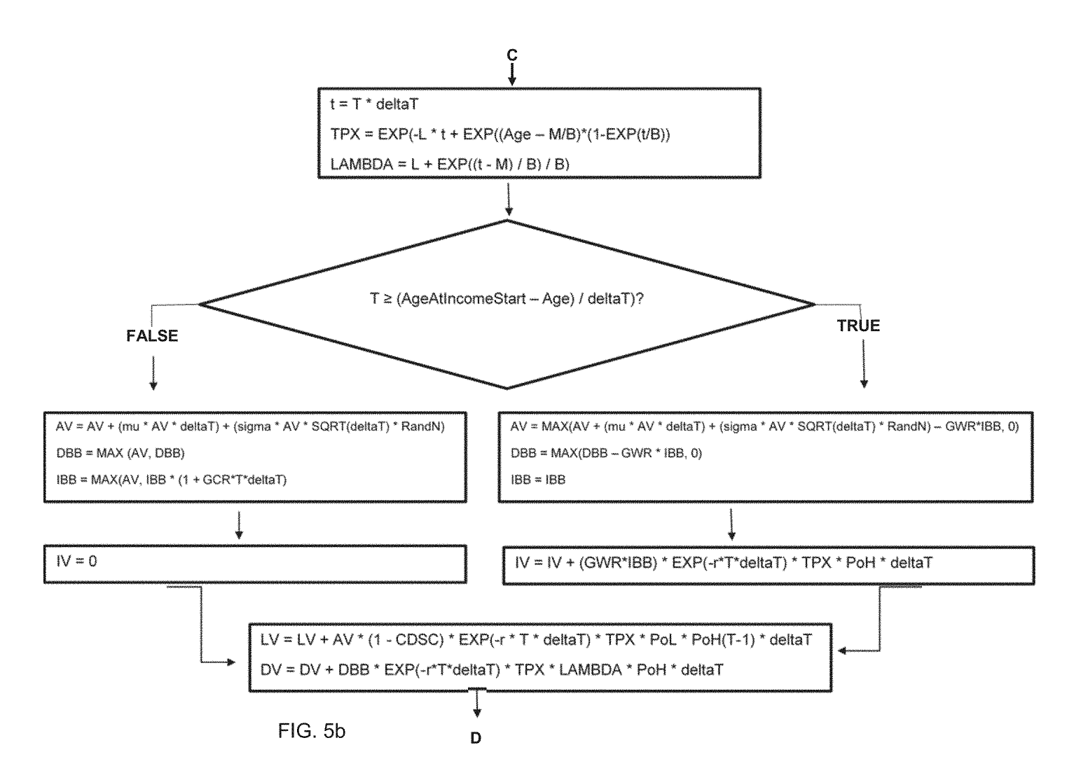

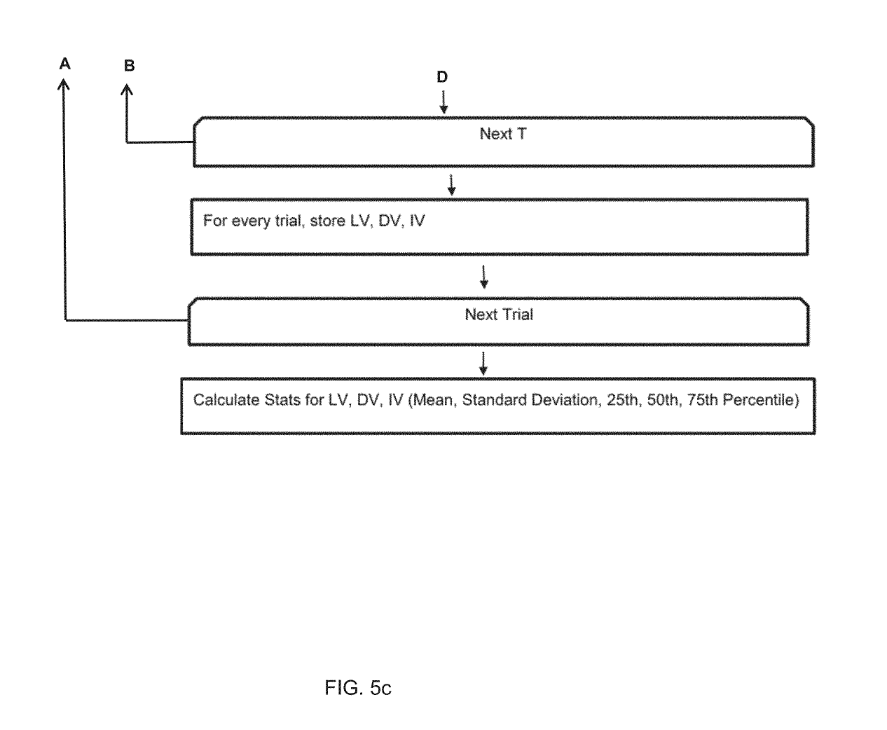

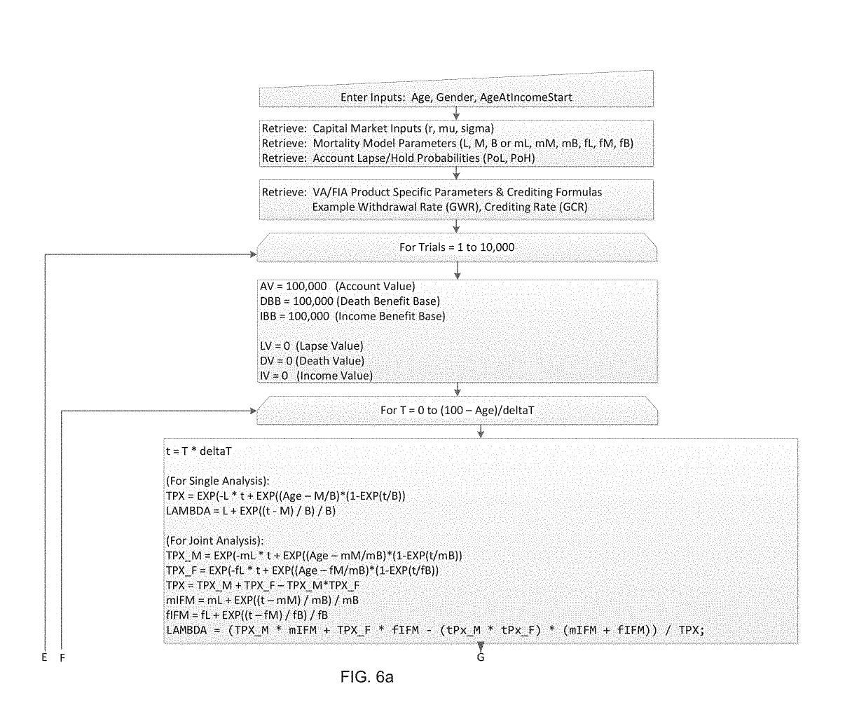

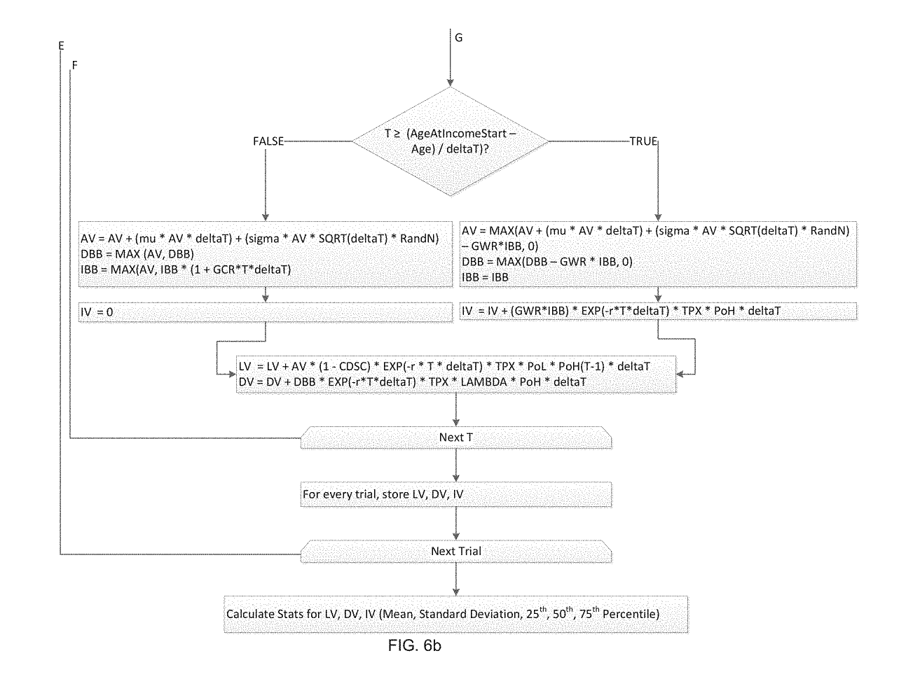

FIGS. 5a-5c provide a flowchart detailing the required calculations for a simple VA with a GLWB to compute the lapse value (LV), death value (DV) and income value (IV) of the VA. FIGS. 6a and 6b provide a similar flowchart detailing the required calculations for a simple VA with a GLWB to compute the lapse value (LV), death value (DV) and income value (IV) of the VA expanded to include joint mortality formulas.

### Step 1: Determine the Economic Value of an Annuity Contract

Fundamentally, the analysis focuses on the three primary “exit options” available with a an annuity. A client can leave or discard an annuity contract by surrendering it, dying, or taking income. So, in the disclosed approach the surrender options, death benefit, and income benefit of two (or more) variable annuity contracts are compared quantitatively, taking into consideration:
The value of the sub-accounts (i.e., the account value);
The value of the “shadow accounts” (i.e., the benefit base for the death and living benefit riders);
Product features in the base contract, as well as in the death and living benefit riders
Any CDSC/surrender fees and their schedules;
Base contract fees and rider fees;
Market returns and volatility; and
Expected mortality given the client's demographic profile (e.g., age and gender).

Then expected performance of each product over time is modelled while focusing on market performance and client demographics. By doing so one can tell if one product is a better investment vehicle considered on its own merit, but one can also go deeper into the analysis and help determine the economic benefit for a particular client based on their situation, needs and preferences.

More precisely, the economic suitability analysis involves first, decomposing a variable annuity into a portfolio of embedded guarantees and secondly, computing their respective values using option pricing methodology. The analysis is performed using Monte Carlo simulation and the outcome of the analysis focuses mainly on the valuation of the downside protections, income benefits, and life insurance protections embedded in the contract.

The analysis breaks an annuity contract into the components lapse value, death value, and income value, as elaborated below.

Lapse value represents the actuarial present value to the client of the flexibility to exit the contract at any point of time. This value is highly dependent on the CDSC schedule provisioned in the contract, the number of years the client has held the product, and industry lapse experience. Generally speaking, the client may be more likely to surrender the contract upon termination of the CDSC period. From this one can conclude that the lapse value is lower for a product that is within its surrender charge period compared to the one for which the surrender period has been completed.

Death value represents the actuarial present value of the life insurance component of the annuity that is provided to the estate upon the death of the policy owner. It is determined based on the relationship between the death benefit base and the account value at the time of death. The value of the death benefit base is mostly driven by rider provisions such as crediting, reset frequency, reset provisions, and any additional deposits and withdrawals.

Income value represents the actuarial present value of future income derived from the annuity, assuming that the maximum allowable withdrawals are taken, such that the benefit base is not negatively impacted. The income that the client is expected to receive from a Guaranteed Lifetime Withdrawal Benefit, for example, is determined in large part by two factors: the withdrawal rate and the income benefit base. The value of the income benefit base is also tied to the account value, rider provisions, reset frequency, crediting rates, and rider fees.

TABLE 1
Example of Economic Value Assessment

| Economic Value | |
|---|---|
| Component | |
| Lapse/Surrender | $39,600 |
| Death Benefit | $23,200 |
| Income Benefit | $53,100 |
| Economic Value | $115,900 |

### Step 2: Determine the Net Economic Value of a Proposed Annuity Transaction

The economic value of each annuity contract is the aggregated value of each of the components noted in Step 1. This value, once completed, can be used to determine the net economic value of a proposed transaction (sale, surrender, exchange, lapse, or at death) by calculating the difference between the economic values of two annuity contracts.

In general, a transaction is considered economically suitable if the net economic value is positive as shown below in Table 2 for a hypothetical example.

TABLE 2
Example of Economic Valuation for a 1035 Exchange

| | Product A | | Product B | |
|---|---|---|---|---|
| | Value | Std. Dev. | Value | Std. Dev. |
| Lapse/Surrender | $39,600 | 34% | $40,800 | 34% |
| Death Benefit | $23,200 | 40% | $23,900 | 36% |
| Income Benefit | $53,100 | 16% | $54,600 | 16% |
| Economic Value | $115,900 | 32% | $119,300 | 30% |
| | | | Net Economic | |
| | | | Value: | |
| | | | $3,400 | |

In the case of a new annuity transaction, this analysis can also be applied across a group of contracts accordingly as shown in Table 3 below for a hypothetical sample.

TABLE 3
Comparing a Group of Contracts

| | Economic Value | | Lapse/Surrender | | Death Benefit | | Income Benefit | |
|---|---|---|---|---|---|---|---|---|
| | | Std. | | Std. | | Std. | | Std. |
| | Value | Dev. | Value | Dev. | Value | Dev. | Value | Dev. |
| Product A | $115,900 | 32% | $39,600 | 34% | $23,200 | 40% | $53,100 | 16% |
| Product B | $119,300 | 30% | $40,800 | 34% | $23,900 | 36% | $54,600 | 16% |
| Product C | $114,600 | 32% | $39,600 | 34% | $29,500 | 31% | $45,500 | 19% |
| Product D | $112,000 | 32% | $38,400 | 34% | $14,600 | 61% | $59,000 | 14% |
| Product E | $124,000 | 33% | $54,000 | 23% | $20,300 | 43% | $49,700 | 16% |

### Step 3: Explore the Variability (Sigma) Around Average Values

Whereas the economic value is the average of all of the Monte Carlo simulations, a standard deviation can also provide us with a measure of the variability of the outcomes around the average value, as exemplified in Table 4 below.

TABLE 4
Adding Standard Deviation to Economic Value Assessment

Product A

| Economic Value Component | Value | Std. Dev. |
|---|---|---|
| Lapse/Surrender | $39,600 | 34% |
| Death Benefit | $23,200 | 40% |
| Income Benefit | $53,100 | 16% |
| Economic Value | $115,900 | 32% |

A higher standard deviation value indicates that there is a greater variability or uncertainty around the outcome. A lower value, on the other hand, indicates lower variability, or lesser uncertainty around the economic value. Economic value together with its accompanying standard deviation provides a better or deeper view of the outcomes so that the investor is able to make a better-informed decision. A client should be aware of the variability of potential outcomes when assessing values between products.

The analysis can also be carried out for specific guarantees allowing a client or advisor to focus on a single benefit compared across products based on a client's preferences or needs for liquidity, income, and/or financial legacy.

In addition, other “non-economic” needs and preferences may have an impact on the overall suitability of a transaction for a client. While these are not taken into consideration in this quantitative analysis, the individual components of the analysis can be drawn out from the economic analysis and considered in order to better align the product with planning needs expressed by the client (e.g., a preference for liquidity over a death benefit).

This analysis is performed on a pre-tax basis, assuming that tax treatment is equal for all products—although there are sonic product designs that require sonic use of tax assumptions that impact the performance of a rider. The analysis also assumes the same investment performance for each product while also recognizing that certain equity and volatility limitations may exist in certain cases. For example, consider an ammeter, used to measure current, which can be mounted in any position to get accurate measurements in electric power systems. Ultimately, the goal is to pass the same “electrical current” through the insurance policy to adequately measure the return (and uncertainty) associated with the contractual guarantees given the combination of riders and base contract options chosen by the investor (client).

In short: by breaking out the basic components of the contract, the advisor is in a better position to match (and document) the preferences of the client with the anticipated value they will receive.

Three common transactional scenarios are considered herein as examples: an annuity exchange, a buyout offer, and a new sale with new assets. The purpose of these cases is to highlight the differences (or gaps) between prior art qualitative practices of comparing specifications between products versus a quantitative assessment in which an economic valuation is performed. Each assessment can be positioned in a variety of ways depending upon the client profile and situation in which the transaction is taking place.

The case analysis herein is based on two hypothetical model clients: Jill, a 67-year-old female, and Mark, a 73-year-old male. Both Jill and Mark have existing VA contracts from which they have decided to start receiving guaranteed income (via a (MB) at the age of 71; an income start age that aligns with IRS minimum distribution requirements. This means that Mark has already triggered his income benefit, while Jill still has a few more years of accumulation before her income starts.

With respect to the products, for all three cases stylized representations of contracts that have been popular in the market, referred to herein as “Product A” and “Product B” are employed. For both sample products, specifications that could potentially have a material impact on the valuation analysis are employed. The characteristics of the two sample products are summarized in Table 5 below.

TABLE 5
Sample Variable Annuity Products with GLWB - Jill and Mark

| | Product A | Product B |
|---|---|---|
| Base Contract Specifications | | |
| Mortality & Expense Fee | 0.95% | 0.85% |
| (Tier 1) | | |
| Mortality & Expense Fee | n/a | 1.10% (at GLWB |
| (Tier 2) | | start) |
| Mortality & Expense Fee | Daily | Daily |
| Frequency | | |
| Administrative Fee | 0.20% | 0.15% |
| Administrative Fee Frequency | Daily | Daily |
| Asset Management Fee | 1.0% | 1.0% |
| Asset Management Fee | Daily | Daily |
| Frequency | | |
| CDSC Schedule (Year/Rate) | 7%, 7%, 7%, 6%, | 5%, 4%, 3%, |
| | 6%, 5%, 4%, 3% | 2%, 1% |
| Rider Specifications | | |
| Living Benefit Rider | GLWB Rider A | GLWB Rider B |
| Fee | 0.75% | 1.25% |
| Fee Frequency | Annually | Annually |
| Crediting Rate (i.e., Roll-Up) | n/a | 5.0% |
| Step-Up Frequency | Annually | Annually |
| Withdrawal Rae | 5.0% (Age <65) | 4.3% (Age <65) |
| (@ Income Start) | 5.5% (Age 65-69) | 5.3% (Age 65-79) |
| | 6.0% (Age 70-74) | 6.3% (Age 80+) |
| | 6.5% (Age 75-79) | |
| | 7% (Age 80+) | |
| Death Benefit Rider | Standard DB | Standard DB |
| | Rider A | Rider B |
| Fee | 0.0% | 0.0% |
| Rider Frequency | Annually | Annually |
| Step-Up Frequency | Monthly | Monthly |

### Case 1: Annuity Exchange (or Replacement)

Annuity replacements, also known as 1035 exchanges, currently account for approximately 50% of annuity sales each year, and are the focus of the first case. A Section 1035 Exchange refers to the replacement of an annuity or life insurance policy for a new one without incurring any tax consequence for the exchange. The IRS allows holders of these types of contracts to do this in order to replace outdated contracts with new contracts with improved benefits, lower fees and different investment options. Section 1035 is a provision of the U.S. tax code that gives a policyholder the ability to transfer funds from a life insurance, endowment or annuity to a policy of a similar type.

When performing an economic valuation of an annuity replacement, the primary objective is to understand the “moneyness” of the contract and what it means to the client when options are in the money or out of the money. In finance, moneyness is the relative position of the current price (or future price) of an underlying asset with respect to the strike or exercise price of a derivative, most commonly a call option or a put option. Moneyness is understood as a three-fold classification: if the current price of the underlying asset is greater than the exercise price, then the option is said to be “in-the-money”; if the current price is less than the exercise price, then it is “out-of-the-money”; if equal, then it is “at-the-money”. As stated earlier approach for determining the economic suitability of a VA transaction disclosed herein uses option pricing methodology, and a living benefit on a variable annuity can be thought of as a kind of put option that is triggered when the contract enters the annuity phase.

The term moneyness, and the associated options pricing methodology, are used to describe the relationship between the benefit base value and the actual account value. A goal of this approach is to understand the implications of moving from a benefit (or multiple benefits) that has been performing under an existing contract and determine the potential performance of that benefit if the existing contract was retained, or alternately if the benefit was “re-booted” within a new one.

When contemplating a section 1035 exchange, it is important to understand the client's purpose for the exchange. Any features that are lost if an existing contract is exchanged may have been more valuable based on the accumulated imbedded value invested in that contract, compared with features in a new VA that may appear attractive but, in reality, have no material impact if they are not fully realized. For example: an enhanced death benefit in a new VA contract, while it could be characterized as an improvement over an existing contract, may provide meagre value to a client if her purpose fur the product is to maximize living (not death) benefits.

In this case, Jill (age 67) will qualify for a guaranteed withdrawal rate of 6% under the old contract and 5.3% with the new contract based on her target income start at age 71 (as noted in FIG. 7). Mark (age 73), on the other hand, will receive a withdrawal rate of 6.0% with the existing and 5.3% with the new contract given that he started taking income two years ago. Table 6 shows the values of the various accounts at the time of the transaction:

a. Qualitative Assessment for Jill & Mark

TABLE 6
Account Values for Products A and B at
the time of a Section 1035 Exchange

| | Product A (old) | Product B (new) |
|---|---|---|
| Account Value | $171,500 | $171,500* |
| Income Benefit Base | $244,010 | $171,500 |
| Death Benefit Base | $173,230 | $171,500 |

*assumes no up-front sales charge

First, the exchange decision for Jill is assessed by examining the comparative specifications of each product (as set out in Table 3). The following may be observed

### Product A (Existing Product)

A CDSC Fee would not apply since both Jill and Mark are outside of the surrender charge period.

The total fees for the existing contract (Product A) are higher than Product B.

The living benefit for Product A is quite valuable given that the income benefit base is substantially higher than the account value, plus:
the living benefit rider fee is 50 bps lower than Product B; and
the withdrawal rate will be higher if Jill and Mark stay with Product A.

The death benefit base is slightly higher than the account value. This implies that this benefit is not as valuable given that Jill still has four years to go until she starts income. In all likelihood the account value will surpass the death benefit base and a higher watermark will be locked in (if Jill keeps Product A until income begins)

### Product B (New Product)

The benefit bases will be equal to the account value upon purchase of the new contract (in this case, there are no up-front sales charges associated with the new product).

For the living benefit, there is an additional crediting rate (i.e., Roll-Up) of 5% that is applied annually. However, the withdrawal rate associated with both Jill's and Mark's income start is 5.3%—which is slightly lower than Product A.

### Conclusion

Overall, based on this qualitative analysis, the recommendation for both Jill and Mark may be to not proceed with the exchange transaction due to the following reasons:
Product A has a higher income-generating potential due to a higher benefit base as well as a higher withdrawal rate,
Product A has a higher death benefit base, and
Product A provides more flexibility to surrender the contract.
   b. Quantitative Assessment for Jill (Economic Valuation)

Consider what the recommendation may look like when running both products through an independent analytical process to determine the value of the guarantees embedded in the two products, as shown in Table 7 below.

TABLE 7
Economic Valuation for Jill - 1035 Exchange

| | Product A (old) | | Product B (new) | |
|---|---|---|---|---|
| | Value | Std. Dev. | Value | Std. Dev. |
| Lapse/Surrender | $69,400 | 28% | $62,100 | 37% |
| Death Benefit | $30,700 | 45% | $38,000 | 42% |
| Income Benefit | $92,500 | 14% | $74,200 | 18% |
| Economic Value | $192,600 | 29% | $174,300 | 36% |

Net Economic Value: ($18,300)

The overall net economic value of the transaction is negative. Further, the uncertainty around the net economic value has gone up, as reflected by the increase in the standard deviation.

However, one area of improvement is the value of legacy (or death benefit). If the primary purpose of this transaction was focused on an improvement in the death benefit, then this transaction was beneficial to the client.

On other hand, if income generation was the primary objective, then this transaction is clearly futile despite the generous base crediting (i.e., the roll-up rate) that Jill would receive during the accumulation phase of the new product before starting the withdrawal benefit in four years. Her existing product would likely produce a better income benefit over time due to the step-ups (i.e., high-water marks) and accumulated value already achieved with the benefit base while the original contract is in force—this is what is meant by the idea that the client's accumulated embedded benefit in the product has value.

c. Quantitative Assessment for Mark (Economic Value)

Consider how the same transaction would be assessed for Mark—given his client profile, and the fact that he has already started taking income from the existing contract, as shown in Table 8 below.

TABLE 8
Economic Valuation for Mark - 1035 Exchange

| | Product A (old) | | Product B (new) | |
|---|---|---|---|---|
| | Value | Std. Dev. | Value | Std. Dev. |
| Lapse/Surrender | $42,000 | 25% | $38,300 | 36% |
| Death Benefit | $36,200 | 34% | $58,000 | 31% |
| Income Benefit | $107,000 | 5% | $75,300 | 11% |
| Economic Value | $185,100 | 18% | $171,600 | 26% |

Net Economic Value: ($13,500)

Overall, in Mark's case the impact to the death and income benefits would be the same as in Jill's case; and produce a negative net economic value for the transaction. However, the variability of the income benefit value for Mark is smaller, compared to Jill's transaction. This is most probably due to the fact that Mark was already taking income from his existing VA and the new income benefit from the new product started immediately upon the exchange.

Also of note, the increase in death benefit value was greater than in Jill's case. The assessment and transaction recommendation is the same for both, i.e. the exchange is not in the best interest of the clients.

d. Summary of Case 1 Results

For Case 1, one view would be that the quantitative analysis validates the original qualitative assessment and the ultimate recommendation to not proceed with the transaction. However, if the client had indicated that improvement of the death benefit was more important than other factors, then there may be a reason to complete the exchange. The quantitative valuation, as performed above, helps to explore and would help to justify the transaction in an objective manner based on economic, financial, and actuarial principles.

Looking at Case 1 as a whole, the Table 9 below summarizes the results of the qualitative and quantitative assessment for Jill and Mark (above) and highlights the situations where the qualitative assessment and quantitative analysis do not agree.

TABLE 9
Qualitative and Quantitative Methods to Assess a Proposed
VA Exchange: How do the two methods compare?

| | | Which is better? | |
|---|---|---|---|
| | | Qualitative | Quantitative |
| | | Comparison of | Comparison of |
| | | Products A & B | Products A & B |
| | | (Specifications) | (Net Economic Value) |
| Jill | Surrender Value | A | A |
| | Death Benefit | A | B |
| | Income Benefit | A | A |
| | Overall Benefit | A | A |
| Mark | Surrender Value | A | A |
| | Death Benefit | A | B |
| | Income Benefit | A | A |
| | Overall Benefit | A | A |

In this case, the economic valuation process helps the advisor meet their compliance and regulatory obligations by proving (or disproving) the economic benefit of a transaction for their client, taking into account the client's preferences.

### Case 2: Buyout Offer

Product manufacturers have the ability to provide a cash incentive for a client to surrender, transfer or purchase a new product. In this case, whether or not a cash offer to surrender a contract is in the best interest of the client should be assessed, regardless of whether the buyout is being offered by the provider of the new contract or the old.

Consider how large the buyout offer needs to be in order to sufficiently cover the lost benefit from a surrendered contract. Consider a range of typical or plausible cash buyout offers of between $15 k and $50 k. In some situations there may be a trade-off in the valuations between the income benefit and a death benefit. Ultimately the transaction is beneficial when the valuation is higher across all of the economic value components.

Consider the same two products from the previous case (in Table 3) and again consider the impact of the transaction for Jill (age 67) and Mark (age 73). The starting values for each product will also be similar, but a buyout offer received immediately as the exchange is completed is added. The cash incentive to the account value of the new product only is also added. One would expect to see an increase in the total economic value of the new product, as well as all of its components to a certain degree. However, one should not expect an increase in value for the exact amount of the cash incentive due to the fact that the calculations are averaged across multiple random scenarios. Table 10 shows an array of buyout offers from $15 k to $50 k.

TABLE 10
Comparing Products A and B when a cash buyout offer is added

| | Product A (old) | Product B (new) |
|---|---|---|
| Account Value | $171,500 | $171,500 |
| Income Benefit Base | $244,010 | $171,500 |
| Death Benefit Base | $173,230 | $171,500 |
| Buyout Offer | Option 1 = $15,000 | n/a |
| | Option 2 = $20,000 | |
| | Option 3 = $30,000 | |
| | Option 4 = $40,000 | |
| | Option 5 = $50,000 | |

a. Qualitative Assessment for Jill and Mark

As in the first case, consider a qualitative effort to assess the decision to accept the buyout offer by examining the comparative specifications of each product. The goal is to determine how large the incentive should be for the transaction to be economically valuable.

The results of a qualitative assessment from Case 1 are still valid for this buyout situation. The issue is whether or not a $25 k buyout offer is good enough to improve the income benefit; and secondly, how a buyout would impact the death benefit. Clearly the buyout amount is sizable compared to the account value, but a key issue is whether it is enough to make up for the benefit accumulated in Product A (lost if the product is exchanged).

Given the crediting rate (i.e., roll-up) available with Product B, it is clear that a suitable incentive (one that will leave the client better-off than his or her existing situation) could be less than $70 k (the amount required to “even out” the income benefit base for both products) and must be higher than $2 k (the minimum to even out the death benefit base)

It also appears that any incentive amount will increase the total value of the transaction, but it is not quite clear at what incentive level the income-generating capabilities of Product A would be matched.

If one is to take a (qualitative) guess, a buyout offer of $35 k to $40 k should be enough, given that the crediting rate in Product B can come close to matching the benefit base values in Product A and be in a better position to lock in future market gains.

b. Quantitative Assessment for Jill (Economic Valuation)

For this buyout case, the valuation process is applied and different cash incentive amounts and their respective effects on the decision and outcome of transaction in Table 11 below are examined.

TABLE 11
Assessing a $15k buyout offer for Jill

| | Product A (old) | | Product B (new) | |
|---|---|---|---|---|
| | Value | Std. Dev. | Value | Std. Dev. |
| Lapse/Surrender | $69,400 | 28% | $67,500 | 37% |
| Death Benefit | $30,700 | 45% | $41,300 | 42% |
| Income Benefit | $92,500 | 14% | $80,600 | 18% |
| Economic Value | $192,600 | 29% | $189,400 | 36% |

Net Economic Value: ($3,200)

In this case, the quantitative analysis demonstrates that $15 k is not a significant enough of an offer to switch from Product A to Product B. Not only does the economic value decrease, but the uncertainty around that value increases as well. Also, the increase in death value is not sufficient to classify this as a beneficial transaction. The income benefit with the existing product is superior, partly because of the higher withdrawal rate and partly because the roll-up feature in the new product was not enough to bridge the gap between the benefit base values of the existing and proposed products.

In terms of legacy, there is an increase in the death benefit value after the transaction, along with a corresponding decrease in uncertainty. Overall, $15 k may be a sufficient offer if the objective was to achieve a higher legacy value.

However, from the income point of view (and regardless of incentive and the better income specifications of Product B), the accumulated income benefit value in Product A prevails. The uncertainty around the income value is also lower (which is positive), thus making Product A in this situation superior.

TABLE 12
Assessing buyout offers for Jill - $15k, $20k & $30k

| | | | Product B @ | | Product B @ | | Product B @ | |
|---|---|---|---|---|---|---|---|---|
| | Product A | | 15k | | 20k | | 30k | |
| | | Std. | | | | Std. | | Std. |
| | Value | Dev. | Value | Std. Dev. | Value | Dev. | Value | Dev. |
| Lapse/Surrender | $69,400 | 28% | $67,500 | 37% | $69,300 | 37% | $73,000 | 37% |
| Death Benefit | $30,700 | 45% | $41,300 | 42% | $42,400 | 42% | $44,600 | 42% |
| Income Benefit | $92,500 | 14% | $80,600 | 18% | $82,800 | 18% | $87,100 | 18% |
| Economic | $192,600 | 29% | $189,400 | 36% | $194,500 | 36% | $204,700 | 36% |
| Value | | | | | | | | |

| | | |
|---|---|---|
| Net Economic | Net Economic | Net Economic |
| Value: ($3,200) | Value: $1,900 | Value: $12,100 |

Between $15 k and $20 k, there is a shift into positive net economic value territory. Consider the investor's preference for income versus the death benefit.

After a $30 k incentive, a higher net economic value is observed. However, there is no significant improvement to the income benefit value as the incentive increases.

Ultimately, with a $50K offer, all values are better on average. Therefore, this can be considered an excellent transaction for the client, regardless of the client's objectives in considering the offer.

TABLE 13
Assessing a $50k buyout offer for Jill

| | Product A (old) | | Product B (new) | |
|---|---|---|---|---|
| | Value | Std. Dev. | Value | Std. Dev. |
| Lapse/Surrender | $69,400 | 28% | $80,200 | 37% |
| Death Benefit | $30,700 | 45% | $49,100 | 42% |
| Income Benefit | $92,500 | 14% | $95,800 | 18% |
| Economic Value | $192,600 | 29% | $225,100 | 36% |

Net Economic Value: $32,500

### Another Look at the Results

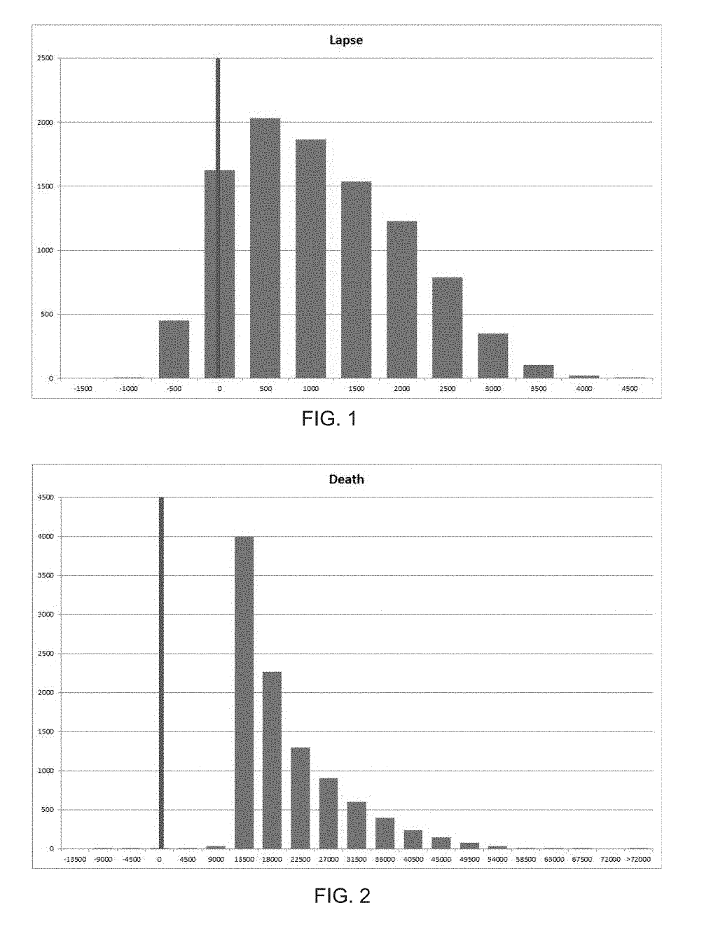

By comparing the distribution of outcomes between Product A and Product B, and displaying them in the form of a histogram (in FIGS. 1-4), one can gain additional insight into the probabilities associated with each benefit value.

Referring to FIG. 1, one can conclude from this histogram that the Lapse Value of Product B was higher in 82% of scenarios and by average of $10,700, with deviation of $11,100. This tells us that in vast majority of cases, a client would have been better off by accepting the buyout offer at $50,000.

Referring to FIG. 2, one can similarly analyze the death value distribution and confirm that Product B was superior in almost every scenario ran with an average difference of approximately $18 k. This undoubtedly shows that from a legacy standpoint this transaction was greatly beneficial to the client.

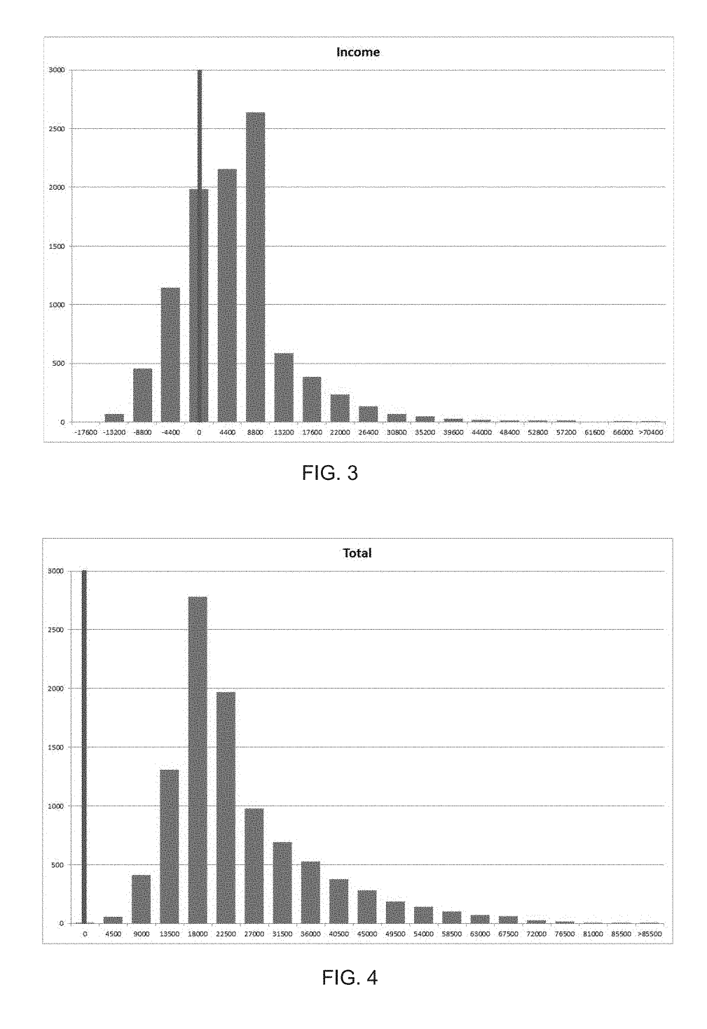

Referring to FIG. 3, in terms of income value, the situation is not that clear. This option value is indeed higher on average, but a closer look into the distribution of possible outcomes provides an additional dimension that merits consideration. In this case, Product B was dominant in 63% of scenarios generated, which is significant but cannot be classified as an absolute success.

Referring to FIG. 4, this additional analysis shows that an economic trade-off is still present and that there's a range of outcomes. As a result, one has to be very careful when assessing transactions involving multiple variable annuities, especially when living benefit riders are in place. Additional quantitative analysis can be helpful in making more informed decisions which are in the best interest of the client, as well as in compliance with regulatory requirements.

Understanding how the benefit is skewed as well as how widely it is distributed helps tell the story of the potential benefit to the investor.

c. Quantitative Assessment for Mark (Economic Value)

Consider this assessment in Mark's situation.

TABLE 14
Assessing a $15k buyout offer for Mark - $15k Incentive

| | Product A (old) | | Product B (new) | |
|---|---|---|---|---|
| | Value | Std. Dev. | Value | Std. Dev. |
| Lapse/Surrender | $42,000 | 25% | $41,600 | 36% |
| Death Benefit | $36,200 | 34% | $63,100 | 31% |
| Income Benefit | $107,000 | 5% | $81,900 | 11% |
| Economic Value | $185,200 | 18% | $186,600 | 26% |

Net Economic Value: $1,400

It appears that this transaction was beneficial based on the final net economic value. However, observe that the uncertainty around the net economic value also went up. At this point one has to consider the client's preferences along with the underlying motives for the transaction. For example, one client might be interested in securing a higher level of predictable income in retirement, whereas another might want to keep liquidity along with a larger potential bequest value.

This explanation also applies to offers of $15K, $20K and $30K where the death benefit value continues to increase but the income value is still inferior. The letter “k” or “K” is used herein to indicate multiples of 1000. For example, $40K refers to $40,000.

Finally, for $50 k, all of the values for the new product increase, but the income benefit never catches up, as opposed to Jill's case. The death value is increasing, but solely due to a cash bonus. The net economic value is positive, but if Mark's objective is to gain a higher income benefit, then the $50 k incentive received at the exchange also falls short of that objective.

TABLE 15
Assessing a $50k buyout offer for Mark

| | Product A (old) | | Product B (new) | |
|---|---|---|---|---|
| | Value | Std. Dev. | Value | Std. Dev. |
| Lapse/Surrender | $42,000 | 25% | $49,400 | 36% |
| Death Benefit | $36,100 | 34% | $74,900 | 31% |
| Income Benefit | $107,100 | 5% | $97,300 | 11% |
| Economic Value | $185,200 | 18% | $221,600 | 26% |

Net Economic Value: $36,400

d. Summary of Case 2 Results

Table 16 summarizes the results and highlights the situations where the qualitative assessment and quantitative analysis do not agree.

TABLE 16
Comparing Products A and B when a cash buyout offer is added.

| | | Which is better? | |
|---|---|---|---|
| | | Qualitative | Quantitative |
| | | Comparison | Comparison (Net |
| | | (Specifications) | Economic Value) |
| Jill @ 15k | Surrender Value | A | A |
| | Death Benefit | A | B |
| | Income Benefit | A | A |
| | Overall Benefit | A | A |
| Jill @ 50k | Surrender Value | A | B |
| | Death Benefit | B | B |
| | Income Benefit | A | B |
| | Overall Benefit | A | B |
| Mark @ 15k | Surrender Value | A | A |
| | Death Benefit | A | B |
| | Income Benefit | A | A |
| | Overall Benefit | A | B |
| Mark @ 50k | Surrender Value | A | B |
| | Death Benefit | B | B |
| | Income Benefit | A | A |
| | Overall Benefit | A | B |

### Case 3: New Sale/New Assets

An economic benefit assessment can also be performed with the first-time purchase of an annuity. In this case, some aspects of the analysis become simplified due to the nature of the transaction because there are no accumulated benefits from an existing annuity contract. In other words, the influence of moneyness is not associated with the decision only the mechanics of each product and the associated fees play a role in determining the economic benefit as part of the recommendation.

Again, looking at all three values combined or individually can help align the quantitative assessment with the client's preferences. Even without the benefit of accumulated benefits, higher fees do not necessarily correspond with a lower comparative value against competing products.

a. Qualitative Assessment for Jill and Mark

With a new sale one has to take a closer comparative look given the fact that all account values and benefit bases start at par. Again, products A and B are compared, but considering a new sale that chooses between them, not exiting or retaining Product A.

At first glance, one suspects that due to lower fees and higher withdrawal rates Product A would be preferred to generate future income. Although Product B has an additional crediting rate while in accumulation phase, this is countered with higher base contract and rider fees along with a lower guaranteed withdrawal rate which could theoretically reduce the potential value of the income benefit. The roll-up rate comes into play in a down market and one is inclined to believe that a continuous negative market condition over entire income delay period of four years for Jill will not transpire. As such these two products look close to indistinguishable in terms of income-generating capabilities.

In terms of surrender flexibility, Product B seems to have a shorter and more favorable CDSC schedule. Likewise, due to the lower overall level of fees, one can expect that the legacy value of Product A would be higher. However, one can argue that the lower level of withdrawals in Product B would work in favor in wealth preservation. Ultimately, taking a qualitative approach, one cannot conclusively determine which product should he recommended for sale.

The recommendation becomes even more complicated when one tries to incorporate client preferences and attempts to make a recommendation that would be in the best interest for the client.

b. Quantitative Assessment for Jill (Economic Valuation)

TABLE 17
Economic Valuation for Jill - New Sale

| Economic Value | Product A | | Product B | |
|---|---|---|---|---|
| Component | Value | Std. Dev. | Value | Std. Dev. |
| Lapse/Surrender | $40,600 | 38% | $37,300 | 37% |
| Death Benefit | $27,000 | 49% | $22,800 | 42% |
| Income Benefit | $42,400 | 15% | $44,600 | 18% |
| Economic Value | $110,000 | 38% | $104,700 | 36% |

Net Economic Value: ($5,300)

When looking at the valuation of two new products from a quantitative point of view the story becomes slightly more interesting. One can see that the economic value of Product A is better along with a slightly higher standard deviation. However, the income benefit value for Product B is higher at the expense of trading some value from the death benefit.

In terms of surrender value, even though there is a difference with CDSC schedules, it appears that in the long run both products offer similar flexibility when industry lapse experience is incorporated in the model. In this situation one can also see that the crediting rate received within Product B, while deferring income, provides a higher income value despite higher tees paid for the rider.

Higher overall fees within Product B contribute to the lower death benefit value compared to Product A. This can be confirmed by looking at additional statistics within a simulation as done above in Case 2. In terms of legacy, Product A was better 98% of time, however, it was only superior in 69% of observations when it came to income.

Since these two products perform very differently, it is important to know about Jill's preferences. Performing a thorough quantitative analysis empowers Jill (and her advisor) to make an appropriate choice. The advisor can provide guidance that is in the best interest of the client and at the same time satisfy the compliance and regulatory requirements with the sale of annuities.

c. Quantitative Assessment for Mark (Economic Valuation)

In Mark's case, the economic valuation analysis is as follows:

In this case, the income value is lower for Product B, but the death benefit value is higher. Overall, the uncertainty of both products is lower than in Jill's case, plus Product A has less variation than B (which is the opposite of Jill's valuation).

TABLE 18
Economic Valuation for Mark - New Sale

| Economic Value | Product A | | Product B | |
|---|---|---|---|---|
| Component | Value | Std. Dev. | Value | Std. Dev. |
| Lapse/Surrender | $22,100 | 38% | $23,000 | 36% |
| Death Benefit | $33,900 | 36% | $34,900 | 31% |
| Income Benefit | $49,900 | 7% | $45,300 | 11% |
| Economic Value | $105,900 | 26% | $103,200 | 26% |

Net Economic Value: ($2,700)

d. Summary of Case 3 Results

TABLE 19
Comparing Products A and B - New Sale

Which is better?

| | | Qualitative | Quantitative |
|---|---|---|---|
| | | Comparison | Comparison (Net |
| | | (Specifications) | Economic Value) |
| Jill | Surrender Value | B | A |
| | Death Benefit | ? | A |
| | Income Benefit | A | B |
| | Overall Benefit | ? | A |
| Mark | Surrender Value | B | B |
| | Death Benefit | ? | B |
| | Income Benefit | A | A |
| | Overall Benefit | ? | A |

Conclusion: Not all products (or clients) are created equal, and matching the client's profile and their retirement situation is necessary to determine the largest economic benefit.

### Aligning Valuation With Current Practices

With the new methodology disclosed herein, it is not suggested that the industry replace existing illustration and comparative tools, but rather add the disclosed method to enhance sales and compliance processes and help fill a gap where the determination of economic benefit to the client may be deficient.

Current illustration practices generally include an assessment across three different market scenarios: a negative average return (or a down market in which only the guarantees kick in), a positive average return, and a single random sequence of events across a period of time (e.g., 30 years). There are advantages and disadvantages of this process. The rules and parameters associated with a living benefit are meant to take advantage of some amount of market volatility and a constant average rate of return may not provide an appropriate representation of how a benefit base (i.e., the shadow account) may operate in a realistic environment. By introducing a random sequence, one can get a better sense of performance against volatility; however, the order of that sequence of returns is but one of an infinite number of possibilities. However, these illustrations provide a simple window into the product that a client may be able to understand.

Herein is disclosed an economic valuation process that is supported by a Monte Carlo simulation that relies on several thousand random scenarios to approximate the performance of a rider. However, the presentation of Monte Carlo results “across the kitchen table” to the average investor has traditionally been a challenge. While the current practice is to use average returns or a single sequence, the computation of multiple scenarios is necessary to gauge the overall economic benefit—especially when considering the dynamics of longevity in an actuarial present value. Ultimately, it comes down to how the results are simplified if they are to be presented to a client (assuming that the results of this model and analysis are made available beyond advisor use only). There are many examples of how the results of complex analyses are summarized and communicated in a simple manner. In addition, the information design supporting investment decisions is a growing area of behavioral finance research and practice.

With the disclosed approach, the valuation process with a traditional view of an illustration that not only projects the accumulation of fees over time, but also the associated account value, income benefit and the death benefit. In this case, two comparative products (“A” and “B”) are considered using common assumptions and pricing variables, which allows an advisor to see how the various benefits, values and fees emerge over time. Graphical representations of the results may help further simplify the assessment.

One fundamental difference with this type of illustration table versus traditional tables is that each year represents a point in time average of multiple scenarios.

### Conclusion

Annuities have existed for over two thousand years and the original rationale remains the same: to support retirement or other long-range goals by way of periodic income payments. However, as with any financial instrument, annuities have evolved over time resulting in many variations . . . along with some confusion to the general public. Today, the most popular variation of an annuity is essentially a structured product that not only bundles multiple features into a single contract, but also includes more complicated financial instruments (e.g., put options) to help address the behavioral finance barriers in having investors commit a portion of their nest egg to guarantees that would help secure their retirement future.

Here, a process is defined that helps break apart these bundled solutions in a transparent manner that is intended to allow the advisor and their client better understand the value of what they are purchasing. As a VA product can perform quite differently for each and every individual, a simple comparison of fees and specifications is not sufficient to ascertain what the economic benefit would be to the investor.

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internee, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

What is claimed is:

1. A system comprising a computer processor configured to determine for a client a present economic value and standard deviation of the present economic value of an annuity contract based on a lapse value representing the value to the client of the flexibility to exit the annuity contract at any point of time, a death value representing the present value of the life insurance component of the annuity contract that is provided to the estate upon the death of the client, and an income value representing the actuarial present value of future income derived from the annuity contract, wherein the average value and standard deviation of the lapse value, death value and income value are calculated by the computer processor by performing Monte Carlo simulations.

2. The system of claim 1, wherein the present economic value to the client of the annuity is calculated to be the sum of the average values of the lapse value, death value and income value of the annuity.

3. The system of claim 2, wherein the standard deviation of the present economic value to the client of the annuity is calculated by performing a Monte Carlo simulation to generate the observations.

4. The system of claim 1, wherein the annuity provides a Guaranteed Lifetime Withdrawal Benefit (GLWB) and the income value is determined based on withdrawal rate and income benefit base of the GLWB.

5. The system of claim 1, wherein the Monte Carlo simulations account for prevailing or forward looking capital market assumptions, mortality rates, lapse experiences, or individual annuity design parameters and combinations thereof.

6. A method for evaluating an annuity contract for a client by a computer processor, the method comprising determining, by the computer processor, a present economic value and standard deviation of the present economic value of the annuity contract based on a lapse value representing the value to the client of the flexibility to exit the annuity contract at any point of time, a death value representing the present value of the life insurance component of the annuity contract that is provided to the estate upon the death of the client, and an income value representing the actuarial present value of future income derived from the annuity contract, wherein the average value and standard deviation of the lapse value, death value and income value are calculated by the computer processor by performing Monte Carlo simulations.

7. The method of claim 6, wherein the present economic value to the client of the annuity is calculated to be the sum of the average values of the lapse value, death value and income value of the annuity.

8. The method of claim 7, wherein the standard deviation of the present economic value to the client of the annuity is calculated by performing Monte Carlo simulations to generate the observations.

9. The method of claim 6, wherein the annuity provides a Guaranteed Lifetime Withdrawal Benefit (GLWB) and the income value is determined based on withdrawal rate and income benefit base of the GLWB.

10. The method of claim 6, wherein the Monte Carlo simulations account for prevailing or forward looking capital market assumptions, mortality rates, lapse experiences, or individual annuity design parameters and combinations thereof.

11. A method of selecting one of a plurality of annuities for a client, the method comprising performing the method of claim 6 for each of the annuities and selecting the annuity with the greatest present economic value to the client.
